(19) United States
(12) Patent Application Publication
(10) Pub. No.: US 2026/0049642 A1
(43) Pub. Date: Feb. 19, 2026

(54) ELECTROMECHANICAL BRAKE

(71) Applicant: Robert Bosch GmbH, Stuttgart (DE)

(72) Inventors: Willi Nagel, Remseck/Hochdorf (DE); Herbert Vollert, Vaihingen/Enz (DE)

(21) Appl. No.: 19/115,890

(22) PCT Filed: Dec. 27, 2023
(86) PCT No.: PCT/EP2023/087808

§ 371 Date: Mar. 27, 2025

(30) Foreign Application Priority Data
Feb. 28, 2023 (DE) 10 2023 201 794.6

(51) Int. Cl. F16D 65/18; B60T 13/74; F16D 65/56; F16D 121/24; F16D 125/36; F16D 125/50; F16D 127/02; F16D 127/06; F16D 131/00

(52) U.S. Cl. CPC F16D 65/18; B60T 13/746; F16D 65/567; F16D 2121/24; F16D 2125/36; F16D 2125/50; F16D 2127/02; F16D 2127/06; F16D 2131/00

(57) ABSTRACT

An electromechanical brake. The electromechanical brake includes an electromechanical actuating device which includes an electric motor, which interacts with a transmission, and a ramp mechanism, the ramp mechanism converting a rotational drive movement of the electric motor into a translational movement for applying a braking force. The electric motor and the transmission are arranged coaxially with each other and are at least partially surrounded by the ramp mechanism.

### FIELD

The present invention relates to an electromechanical brake and to a vehicle brake system comprising at least one such electromechanical brake.

### BACKGROUND INFORMATION

Usually, the service brake is a brake that uses brake fluid to press a brake piston together with a brake pad onto a brake disc in order to brake the vehicle. The parking brake, on the other hand, is designed as an electromechanical brake. In the course of the increasing electrification of units in the motor vehicle, the service brake is also to be designed as an electromechanical brake so that brake fluid and the associated complex valve and line structure can be dispensed with. The maintenance effort could also be significantly reduced by such an electromechanical brake.

Germany Patent Application No. DE 10 2007 055 637 A1 describes an electromechanical friction brake in which an electric motor drives one of two cam plates via a transmission. Between the cam plates, rolling bodies are arranged, which roll along wedge-shaped curves of the cam plate and thereby generate a feeding motion. The cam plates have depressions into which the rolling bodies can stably lock to form a parking brake. Wear between cam plates and the brake pad is adjusted by means of a threaded spindle.

An object of the present invention is to specify an electromechanical brake which is smaller and more compact.

The object may be achieved with an electromechanical brake with certain features of the present invention. Preferred example embodiments of the present invention are disclosed herein.

### SUMMARY

The present invention provides an electromechanical brake with an electromechanical actuating device comprising an electric motor, which interacts with a transmission, and a ramp mechanism. To convert a rotational drive movement of the electric motor into a translational movement for applying a braking force, an example embodiment of the present invention has a ramp mechanism. Various ramp mechanisms are conventional. Ball ramp mechanisms with two coaxially arranged discs, between which, for determinacy, typically three balls are arranged in a circumferential distribution, are conventional One of the two discs is rotatably drivable. On or in sides that are facing one another, the discs have ramps extending circumferentially that rise in one circumferential direction, and in which the balls roll. The ramps are typically trench-shaped depressions that become lower in one circumferential direction.

By rotating the one disc, the balls roll in the ascending direction of the ramps and push the discs apart thereby creating the translational movement. In the opposite direction of rotation, the two discs become closer. Other rolling bodies may also be used instead of balls, for example, cylindrical or tapered rollers. These can be mounted rotatably on one disc so that only the other disc has ramps, on which the rollers or other rolling bodies roll. Also, a ramp mechanism without rolling bodies is possible, comprising one or more circumferentially running ramps that press a counter body by means of rotation and thereby produce a translational movement such as with a conventional ball ramp mechanism.

In any case, a ramp mechanism, if it has rolling bodies, has the advantage of low friction. Another advantage of the ramp mechanism is that the slope of the ramps can change over their length. An initially large slope can quickly overcome a clearance space, i.e., a gap between the friction brake pad and the brake body when the friction brake is released. As the brake pads are increasingly under tension, a decreasing slope results in greater transmission of force and thus greater force is generated with limited drive torque.

According to an example embodiment of the present invention, the electric motor and the transmission are arranged coaxially with each other and are at least partially surrounded by the ramp mechanism. The electric motor and the transmission are thus not arranged radially adjacent to each other so that the radial space requirement can be reduced with the corresponding arrangement. Likewise, according to the invention, the electric motor with the transmission and the ramp mechanism are not arranged axially in succession, but rather the ramp mechanism surrounds the electric motor and the transmission. This arrangement of the components significantly reduces an axial space requirement. Accordingly, an electromechanical brake may be provided, which is substantially more compact.

In a preferred example embodiment of the present invention, the ramp mechanism comprises a cup-shaped drive element connected to the transmission and a cam ring. The ramp mechanism thus comprises a cam ring instead of a cam disc so that it can surround at least a part of the axial length of the electric motor and the transmission. The electric motor and the transmission are thus arranged radially centrally with respect to the cam ring. The drive element is connected to an output of the transmission via which it is driven. The cup-shaped configuration of the drive element has a receiving area in which the electric motor and the transmission are received. Accordingly, the cup-shaped drive element also surrounds the electric motor and the transmission so that a compact design is achieved. The cup-shaped drive element is preferably made of plastic so that the weight and cost of such an electromechanical brake can be reduced.

In a further preferred example embodiment of the present invention, a bearing arrangement with at least one radial bearing interacting with the cam ring is arranged between the cam ring and the floor of the housing, via which a braking force can be supported on the floor of the housing. The bearing arrangement comprises a plurality of identical or different bearings. The radial bearing is preferably supported via an edge of the cup-shaped drive element. Via the bearing arrangement, the radial bearing supports the braking force on the floor of the housing. The braking force is thus transmitted to the floor of the housing in a low friction manner.

Preferably, the cam ring is arranged in a brake piston, which together form a mechanism for wear regulation. Particularly preferably, an external thread is arranged on the cam ring and an internal thread is arranged on the brake piston so that the cam ring can be screwed into the brake piston. The arrangement allows an axial length of the brake piston and the cam ring to be changed. Accordingly, by increasing the axial length, wear on the brake pads can be compensated. It is thus possible to form a wear regulation mechanism in a simple manner. By regulating the wear via the cam ring and the brake piston, no further components are required, so that space requirements and component costs can be reduced. An arrangement of the cam ring in the brake piston also has the advantage that the space requirement can be reduced compared to an axial arrangement of components so that the electromechanical brake can be more compactly designed.

In an advantageous further development of the present invention, the cam ring has stops at ends of a curve formed thereon, wherein a rotation of the cam ring in the brake piston can be performed when these stops are reached in order to regulate wear. A stop is a change in the slope of the curve that is large enough to be insurmountable for the rolling body or the radial bearing. By further rotation of the electric motor at these stops, it is possible to rotate the cam ring. It is thus possible to perform wear regulation during operation in a simple manner.

In an alternative example embodiment of the present invention, the drive element and the cam ring comprise engagement means, which engage with one another in a position between the cam ring and the drive element so that a rotation of the cam ring in the brake piston can be performed in order to regulate wear. Such wear regulation is also possible via such an engagement means.

Advantageously, the cam ring has a depression after a rise in a curve formed thereon, such that the brake can be locked in a parked position. This depression in the curve forms a stable position for the rolling body or the radial bearing. As a result, this position may also be kept braked in a parked state of the vehicle, such that a parking brake is formed in a simple manner.

In a further advantageous example embodiment of the present invention, the cam ring comprises an internal gear toothing, which is engaged with a gear configured with a freewheel, such that the cam ring can only be rotated in one direction for wear adjustment. One direction of rotation of the gear is blocked by means of the freewheel. As a result, it is possible to permit only one rotation of the gear, via which wear is adjusted. Such a configuration prevents the cam ring from inadvertently moving against a direction of wear during normal braking operation. The requirements for the thread of the wear adjustment, in terms of sufficiently high thread friction, can thereby be lowered. This increases the safety of the wear adjustment.

According to an expedient embodiment of the present invention, the gear is arranged eccentrically to a cylindrical component attached to the brake piston, which, by a rotation, causes the gear to disengage such that the cam ring can be reset. An eccentric arrangement of the gear to a component axis of rotation makes it possible to alter a distance between the cam ring and the gear by rotation of the component. During maintenance, this makes it readily possible to rotate the cam ring back without having to remove components.

In accordance with a further expedient embodiment of the present invention, compression springs are arranged between brake pads of the brake, via which the brake pads can be separated from a brake disc. The compression springs constantly apply a force to the two brake pads. After a braking operation, the brake pads are quickly separated from the brake disc so that grinding of the pads on the brake disc is reduced to a minimum. This reduces brake pad wear and particulate matter pollution. In addition, a defined clearance space is set via the compression springs after braking. The compression springs additionally ensure that all components in the force flow are pretensioned with a defined force so that there is no free play between the components.

Preferably, the transmission is at least a single-stage planetary gear transmission. A planetary gear transmission has the advantage that a high torque is transferable in a compact manner so that the electromechanical brake can be smaller. The planetary gear transmission additionally allows the electric motor to be designed smaller in size so that design space is also saved as a result. Advantageously, the planetary gear transmission is a two-stage planetary gear transmission.

In addition, according to the present invention, a vehicle brake system is provided, which comprises at least one such electromechanical brake. With such a vehicle brake system, the advantages mentioned above are substantially achieved.

Embodiment examples of the present invention are shown in the figures and explained in more detail in the following description.

### BRIEF DESCRIPTION OF THE DRAWINGS

FIG. 1 shows a sectional view of an electromechanical brake according to a first embodiment example of the present invention.

FIG. 2 shows a perspective view of an embodiment example of a cam ring, according to the present invention.

FIG. 3 shows a sectional view through the drive pulley, according to an example embodiment of the present invention.

FIG. 4 shows a view of a curve of the cam ring, according to an example embodiment of the present invention.

FIG. 5 shows a sectional view of an electromechanical brake according to a second embodiment example of the present invention.

FIG. 6 shows sectional view of an electromechanical brake according to a third embodiment example of the present invention.

FIG. 7 shows an enlarged view of an anti-rotation feature.

### DETAILED DESCRIPTION OF EXAMPLE EMBODIMENTS

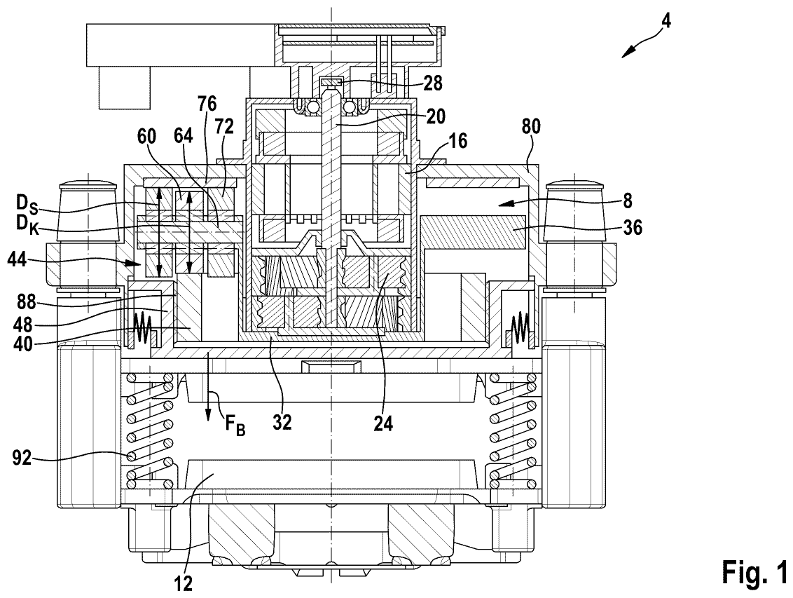

FIG. 1 shows a sectional view of an electromechanical brake 4 according to a first embodiment example of the present invention. The electromechanical brake 4 comprises an actuating device 8, via which a braking force FB can be applied to brake pads 12 of the electromechanical brake. The actuating device 8 comprises an electric motor 16, which is configured as an electronically commutated motor. The electric motor 16 drives a drive axle 20 connected to a transmission 24. In the embodiment example shown, the transmission 24 is configured as a two-stage planetary gear transmission, which is arranged coaxially with the electric motor 16. In order to be able to detect a position of a rotor of the electric motor 16, a rotor position sensor 28 is arranged on a side of the drive axle 20 facing away from the transmission 24.

On the output side, the planetary gear transmission 24 is connected to a cup-shaped drive element 32. The cup-shaped drive element 24 is configured to partially surround the planetary gear transmission 24 and the electric motor 16 on the outer side. Additionally, the cup-shaped drive element 32 forms a ring disc 36 that is arranged coaxially with the drive axle 20. The ring disc 36 together with a cam ring 40 forms a ramp mechanism 44, via which a rotational drive movement of the ring disc 36 can be converted into a translational movement of a brake piston 48 connected to the cam ring 40.

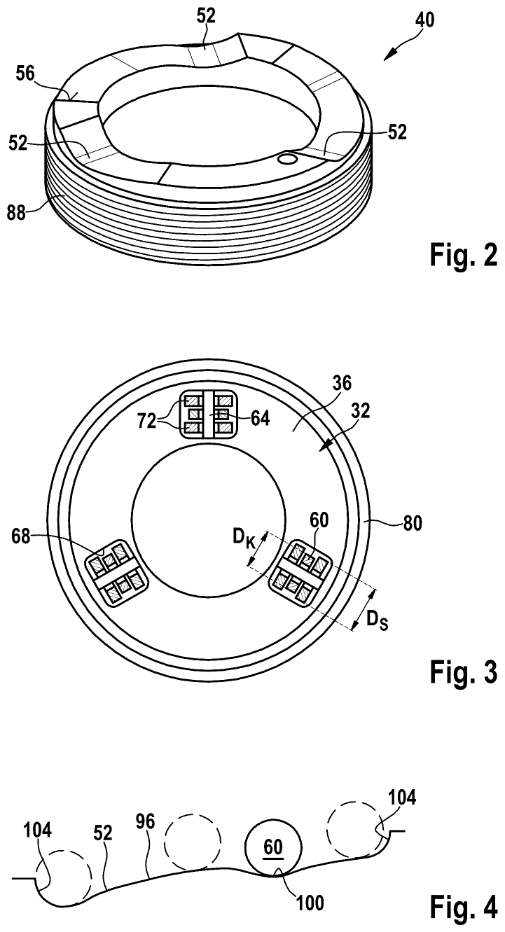

FIG. 2 shows a perspective view of an embodiment example of the cam ring 40. In this figure, it can be seen that the cam ring 40 has three identical curves 52, which are arranged along a front side 56 of the cam ring 40. The curves 52 have different axial elevations of the cam ring 40. Three cam radial bearings 60 shown in FIG. 1 and FIG. 3 interact with the cam ring 40 and roll along the curves 52 of the cam ring 40. As shown in FIG. 3, the cam radial bearings 60 are constrained to the ring disc 36 by means of ring disc axles 64. The ring disc 36 has three notches 68, in each of which a radially extending ring disc axle 64 is arranged.

In addition to the cam radial bearings 60, two support radial bearings 72 are respectively arranged on the ring disc axles 64, which are provided on both sides of the cam radial bearing 60.

Compared to the cam radial bearing 60, the support radial bearings 72 have a larger external diameter D_{S}, as shown in FIG. 1. As a result, the support radial bearings 72 abut a support ring disc 76 located on a floor of the housing 80 of the electromechanical brake 4. Since an external diameter D_{K} of the cam radial bearing 60 is less than the external diameter D_{S} of the support radial bearing 72, this radial bearing 60 does not abut the support ring disc 76. Due to a narrow radial thickness of the cam ring 40, the support radial bearings 76 do not abut the cam ring 40, but instead run freely on both sides of the cam ring 40.

The cam ring 40 is received in the brake piston 48, which acts on the brake pad 12. The brake piston 48 and cam ring 40 each form a thread 88, via which the cam ring 40 is screwed into the brake piston 48. Wear regulation of the brake pads 12 is possible via this thread 88. Accordingly, when the cam ring 40 is screwed in the direction out of the brake piston 48, wear on the brake pads 12 may be adjusted. The thread 88 is configured to prevent rotation generated by a normal operating movement. Compression springs 92 are arranged between the brake pads 12, by means of which the brake pads 12 are pushed apart after a braking operation. This avoids grinding of the brake pads 12 on a brake disc (not shown). The brake pad wear can thus be reduced accordingly.

FIG. 4 shows a view of a curve 52 of the cam ring 40. The curve radial bearing 60 runs on this curve 52. After a first rise 96, a depression 100 is formed, into which the cam radial bearing 60 can stably lock into place. A parking brake function is formed via this depression 100. Additionally, curve 52 has two stops 104 that the curve radial bearing 60 may run into. By means of further rotation beyond these stops 104, it is possible to generate rotation of the cam ring 40 in the brake piston 48. This allows the wear to be regulated in a simple manner. Likewise, after changing a brake pad 12, the wear can be completely reversed.

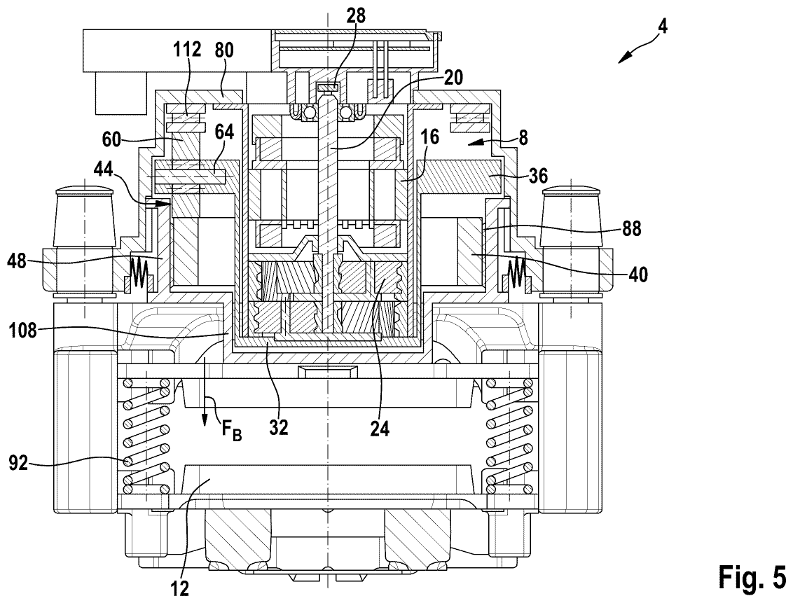

FIG. 5 shows a sectional view of an electromechanical brake 4 according to a second embodiment example of the invention. This embodiment example differs from the electromechanical brake 4 of FIG. 1 in that the brake piston 48 is designed as a stepped brake piston 48. Accordingly, another step 108 is provided in the area of the electric motor 16 and the transmission 24. The electromechanical brake 4 can thus be configured even more compactly. By means of the stepped shape of the brake piston 48, it is possible to place a frontmost portion of the brake piston 48 in the area of a rim.

The embodiment example of FIG. 5 additionally differs from the first embodiment example in that no support radial bearings 72 are provided. In this embodiment example, only the cam radial bearing 60 is provided. Instead of the support radial bearing 72, a support axial bearing 112 is located between the curve radial bearing 60 and the floor of the housing 80. By means of the support axial bearing 112, it is possible for the forces to be transferable to the floor of the housing 80.

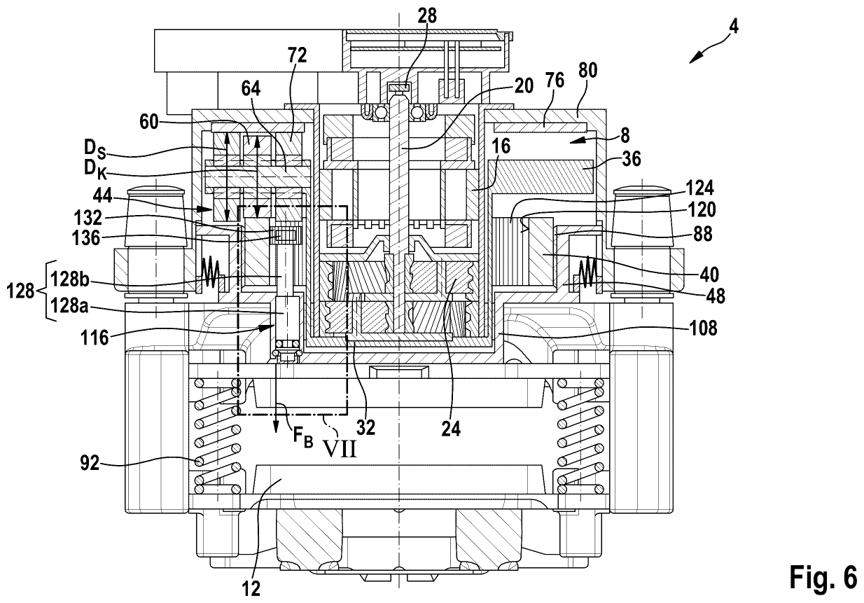

FIG. 6 shows a sectional view of an electromechanical brake 4 according to a third embodiment example of the invention. This embodiment example differs from the embodiment example of FIG. 1 in that an anti-rotation feature 116 is provided for the cam ring 40. By means of this anti-rotation feature 116, only a rotation of the cam ring 40 in one direction is permitted, so that unintended rotation of the cam ring 40 during normal use is prevented. For the anti-rotation feature 116, the cam ring 40 comprises internal gear toothing 124 on an inner peripheral surface 120.

The anti-rotation feature 116 includes a cylindrical pin 128. The pin 128 is divided into two regions 128a, 128b, wherein a first region 128a is located on the brake piston 48. A second region 128b adjoins the first region 128a and extends into the area of the internal gear toothing 124 of the cam ring 40. Attached to the second region 128b of the pin 128 is a gear 132 that engages with the internal gear toothing 124. A freewheel 136 is provided between pin 128 and gear 132 so that gear 132 can only rotate in one direction.

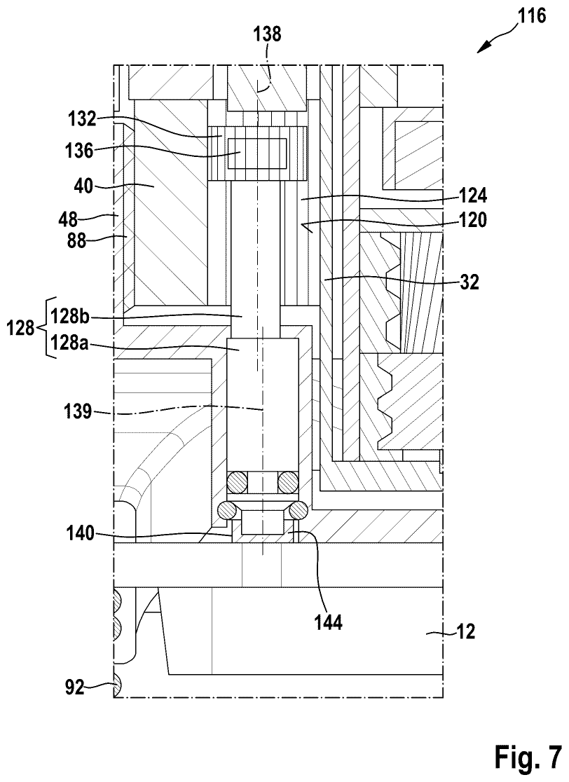

FIG. 7 shows an enlarged view of the pin 128 and gear 132. In this figure, it can be seen that the second region 128b, and thus also the axis of rotation 138 of the gear 132, is provided eccentrically to an axis of rotation 139 of the first region 128a. Thus, rotation of the first region 128a disengages the gear 132 from the internal gear toothing 124. As a result, when brake pad 12 is changed, cam ring 40 may be screwed back into brake piston 48 to be able to reset the wear to zero again.

To avoid unintended rotation of the first region 128a during use, a slot 140 is formed at an axial end of the first region 128a. This slot 140 interacts with a bar 144 of the brake pad such that the bar 144 engages in the slot 140 and rotation is prevented. In addition, this slot-and-bar connection allows for poka-yoke safe installation. If pin 128 is rotated, it is not possible to install the brake pad 12, so that installation of brake pad 12 is only possible with a correctly aligned pin 128.

1-11. (canceled)

12. An electromechanical brake, comprising:
an electromechanical actuating device which includes an electric motor, which interacts with a transmission, and a ramp mechanism, the ramp mechanism configured to convert a rotational drive movement of the electric motor into a translational movement for applying a braking force;
wherein the electric motor and the transmission are arranged coaxially with each other and are at least partially surrounded by the ramp mechanism.

13. The electromechanical brake according to claim 12, wherein the ramp mechanism includes a cup-shaped drive element connected to the transmission and a cam ring.

14. The electromechanical brake according to claim 13 wherein a bearing arrangement with at least one radial bearing interacting with the cam ring is arranged between the cam ring and a floor of the housing, via which a braking force can be supported on the floor of the housing.

15. The electromechanical brake according to claim 13, wherein the cam ring is arranged in a brake piston, which together form a mechanism to regulate wear.

16. The electromechanical brake according to claim 15, wherein the cam ring has stops at ends of a curve formed on the cam ring, wherein, when the stops are reached, the cam ring can be rotated in the brake piston for wear regulation.

17. The electromechanical brake according to claim 13, wherein the cam ring has a depression after a rise in a curve formed on the cam ring so that the brake can be locked in a parked position.

18. The electromechanical brake according to claim 13, wherein the cam ring includes internal gear toothing which is engaged with a gear configured with a freewheel, such that the cam ring can be rotated only in one direction for wear adjustment.

19. The electromechanical brake according to claim 18, wherein the gear is arranged eccentrically to a cylindrical component attached to the brake piston, which, by a rotation, causes the gear to disengage such that the cam ring can be reset.

20. The electromechanical brake according to claim 12, wherein compression springs are arranged between brake pads of the brake, via which the brake pads can be separated from a brake disc.

21. The electromechanical brake according to claim 12, wherein the transmission is at least a single-stage planetary transmission.

22. A vehicle brake system, comprising:
at least one electromechanical brake including:
an electromechanical actuating device which includes an electric motor, which interacts with a transmission, and a ramp mechanism, the ramp mechanism configured to convert a rotational drive movement of the electric motor into a translational movement for applying a braking force;
wherein the electric motor and the transmission are arranged coaxially with each other and are at least partially surrounded by the ramp mechanism.
